(19) United States
(12) Patent Application Publication
(10) Pub. No.: US 2016/0034949 A1
(43) Pub. Date: Feb. 4, 2016

(54) Determining Suspicious Advertisements By Comparing Advertisement Content And Content Associated With An Advertisement Landing Page

(71) Applicant: Facebook, Inc., Menlo Park, CA (US)

(72) Inventor: Benjamin Mark Dowling, Mountain View, CA (US)

(21) Appl. No.: 14/450,183

(22) Filed: Aug. 1, 2014

(51) Int. Cl. G06Q 30/02

(52) U.S. Cl. CPC G06Q 30/0248; G06Q 30/0277

(57) ABSTRACT

A online system receives advertisement (“ad”) requests for presentation to online system users, with each ad request including advertisement content and identifying a landing page. The online system determines whether the advertisement content differs from content associated with a landing page identified by an ad request. One or more topics associated with the advertisement content are identified, as well as one or more topics associated with content on the landing page. By comparing topics associated with the advertisement content to topics associated with the landing page content, the online system determines if the advertisement content and landing page content differ. If the advertisement content differs from the landing page content, the online system may prevent the ad request from being presented or may identify the ad request for manual review.

### BACKGROUND

This disclosure generally relates to advertisements presented by an online system, and particularly to detecting suspicious advertisements in which the advertisement content differs from content associated with landing pages associated with the advertisements.

An online system allows its users to connect to and interact with other online system users and with objects on the online system. The online system also presents advertisements to users of an online system for users to view. Presenting advertisements allows the online system to obtain revenue from advertisers, while allowing the advertisers to present advertisements for products or services to online system users.

Advertisements presented by the online system are frequently associated with a landing page, so when a user interacts with an advertisement, the user is directed to the landing page associated with the advertisement. For example, an advertisement includes a network address (e.g., a uniform resource locator) identifying the landing page, and when an online system user interacts with the advertisement via a client device, the client device retrieves content from the network address and presents the content in an application (e.g., a browser). Typically, the advertisement content presented to a user by an advertisement represents the content included on a landing page. Thus, users interested in content presented by an advertisement interact with the advertisement to obtain additional information from the associated landing page about the content presented by the advertisement. However, malicious advertisers may “cloak” an advertisement by specifying content for presentation by the advertisement that differs from content associated with the advertisement's landing page. For example, an advertisement presents content describing a product, but is associated with a landing page including content unrelated to the described product; hence, when a user interacts with this advertisement, the user is presented with content from a landing page that is unrelated to the product described. In some instances, the landing page content differing from the described product includes malicious content. While many online systems review content, such as advertisements, for malicious content before the content is presented to users, conventional techniques for reviewing content have difficulty identifying malicious content included in a landing page associated with an advertisement.

### SUMMARY

An online system receives advertisements from one or more advertisers for presentation to online system users. In one embodiment, the online system receives an advertisement request (“ad request”) from an advertiser including a bid amount and advertisement content. The ad request also identifies a landing page, so when a user interacts with the advertisement content (e.g., selects the advertisement content), content from the landing page is retrieved and presented to the user. For example, the landing page is a network address and content is retrieved from the network address for presentation. Malicious advertisers may include advertisement content in an ad request that does not represent content associated with a landing page identified by the ad request to direct users to a landing page including malicious content or to a landing page including content with which users are unlikely to have an interest. To enhance the user experience, the online system reviews advertisement content and a landing page identified by an ad request to determine if the landing page is associated with the advertisement content.

The online system identifies advertisement content and a landing page identified by a received advertisement request. By analyzing the advertisement content, the online system identifies one or more topics associated with the advertisement content. For convenience, topics associated with advertisement content are referred to herein as “advertisement content topics.” Similarly, the online system retrieves content from the identified landing page and identifies one or more topics associated with the landing page.

To determine whether the advertisement content and the landing page are associated with matching, or similar, content, the online system scores the ad request based on the advertisement content topics and the one or more topics associated with the landing page. In one embodiment, the ad request's score is based on a number of advertisement content topics matching or similar to topics associated with the landing page. Alternatively, the online system scores the ad request based on a probability of the topics associated with the landing page occurring given the advertisement content topics.

Based on the score associated with the ad request the online system determines if the advertisement content of the ad request differs from content associated with the landing page specified by the ad request. In some embodiments, the online system compares the score associated with the ad request with a threshold value and determines whether the advertisement content differs from content associated with the landing page based on the comparison. If the advertisement content differs from the content associated with the landing page, the online system may flag the ad request for manual review, identify the ad request as ineligible for presentation to users, or perform another suitable action.

### BRIEF DESCRIPTION OF THE DRAWINGS

FIG. 1 is a block diagram of a system environment in which an online system operates, in accordance with an embodiment.

FIG. 2 is a block diagram of an online system, in accordance with an embodiment.

FIG. 3 is a flowchart of a method for determining whether content in an ad request differs from content associated with a landing page specified by the ad request identifying a cloaked advertisement, in accordance with an embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### System Architecture

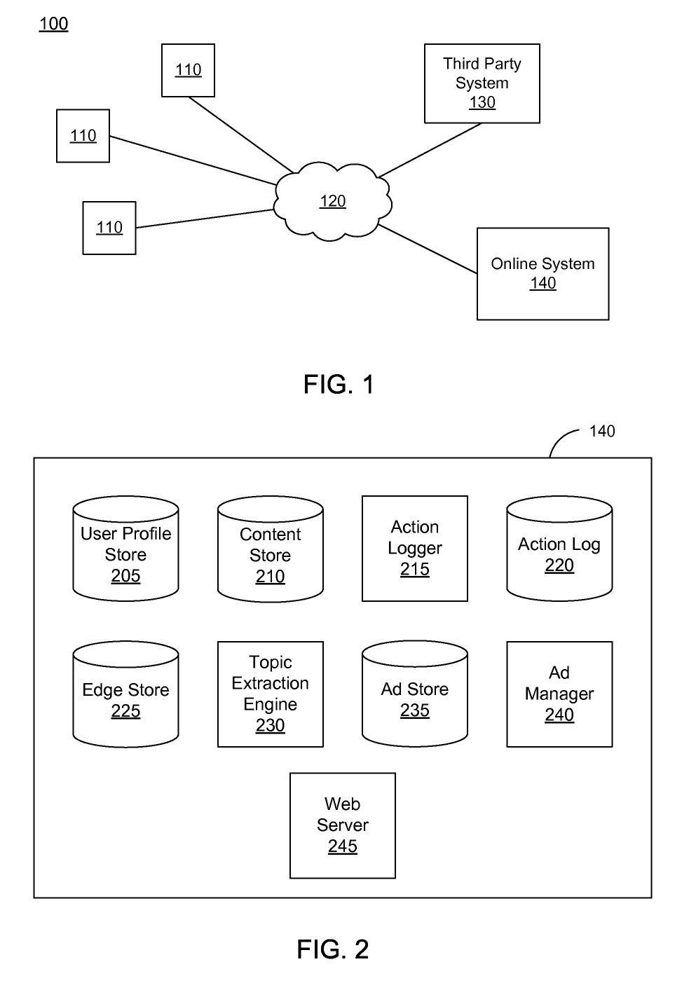

FIG. 1 is a high level block diagram of a system environment 100 for an online system 140. The system environment 100 shown by FIG. 1 comprises one or more client devices 110, a network 120, one or more third-party systems 130, and the online system 140. In alternative configurations, different and/or additional components may be included in the system environment 100.

The client devices 110 are one or more computing devices capable of receiving user input as well as transmitting and/or receiving data via the network 120. In one embodiment, a client device 110 is a conventional computer system, such as a desktop or a laptop computer. Alternatively, a client device 110 may be a device having computer functionality, such as a personal digital assistant (PDA), a mobile telephone, a smartphone or another suitable device. A client device 110 is configured to communicate via the network 120. In one embodiment, a client device 110 executes an application allowing a user of the client device 110 to interact with the online system 140. For example, a client device 110 executes a browser application to enable interaction between the client device 110 and the online system 140 via the network 120. In another embodiment, a client device 110 interacts with the online system 140 through an application programming interface (API) running on a native operating system of the client device 110, such as IOS® or ANDROID™.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

One or more third party systems 130 may be coupled to the network 120 for communicating with the online system 140, which is further described below in conjunction with FIG. 2. In one embodiment, a third party system 130 is an application provider communicating information describing applications for execution by a client device 110 or communicating data to client devices 110 for use by an application executing on the client device. In other embodiments, a third party system 130 provides content or other information for presentation via a client device 110. A third party website 130 may also communicate information to the online system 140, such as advertisements, content, or information about an application provided by the third party website 130.

FIG. 2 is an example block diagram of an architecture of the online system 140. The online system 140 shown in FIG. 2 includes a user profile store 205, a content store 210, an action logger 215, an action log 220, an edge store 225, a topic extraction engine 230, an advertisement (“ad”) store 235, an ad manager 240, and a web server 250. In other embodiments, the online system 140 may include additional, fewer, or different components for various applications. Conventional components such as network interfaces, security functions, load balancers, failover servers, management and network operations consoles, and the like are not shown so as to not obscure the details of the system architecture.

Each user of the online system 140 is associated with a user profile, which is stored in the user profile store 205. A user profile includes declarative information about the user that was explicitly shared by the user and may also include profile information inferred by the online system 140. In one embodiment, a user profile includes multiple data fields, each describing one or more attributes of the corresponding user of the online system 140. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with information identifying online system users displayed in an image. A user profile in the user profile store 205 may also maintain references to actions by the corresponding user performed on content items in the content store 210 and stored in the action log 220.

While user profiles in the user profile store 205 are frequently associated with individuals, allowing individuals to interact with each other via the online system 140, user profiles may also be stored for entities such as businesses or organizations. This allows an entity to establish a presence on the online system 140 for connecting and exchanging content with other online system users. The entity may post information about itself, about its products or provide other information to users of the online system using a brand page associated with the entity's user profile. Other users of the online system may connect to the brand page to receive information posted to the brand page or to receive information from the brand page. A user profile associated with the brand page may include information about the entity itself, providing users with background or informational data about the entity.

The content store 210 stores objects that each represent various types of content. Examples of content represented by an object include a page post, a status update, a photograph, a video, a link, a shared content item, a gaming application achievement, a check-in event at a local business, a brand page, or any other type of content. Online system users may create objects stored by the content store 210, such as status updates, photos tagged by users to be associated with other objects in the online system, events, groups or applications. In some embodiments, objects are received from third-party applications or third-party applications separate from the online system 140. In one embodiment, objects in the content store 210 represent single pieces of content, or content “items.” Hence, online system users are encouraged to communicate with each other by posting text and content items of various types of media to the online system 140 through various communication channels. This increases the amount of interaction of users with each other and increases the frequency with which users interact within the online system 140.

The action logger 215 receives communications about user actions internal to and/or external to the online system 140, populating the action log 220 with information about user actions. Examples of actions include adding a connection to another user, sending a message to another user, uploading an image, reading a message from another user, viewing content associated with another user, and attending an event posted by another user. In addition, a number of actions may involve an object and one or more particular users, so these actions are associated with those users as well and stored in the action log 220.

The action log 220 may be used by the online system 140 to track user actions on the online system 140, as well as actions on third party systems 130 that communicate information to the online system 140. Users may interact with various objects on the online system 140, and information describing these interactions is stored in the action log 220. Examples of interactions with objects include: commenting on posts, sharing links, and checking-in to physical locations via a mobile device, accessing content items, and any other suitable interactions. Additional examples of interactions with objects on the online system 140 that are included in the action log 220 include: commenting on a photo album, communicating with a user, establishing a connection with an object, joining an event, joining a group, creating an event, authorizing an application, using an application, expressing a preference for an object (“liking” the object), and engaging in a transaction. Additionally, the action log 220 may record a user's interactions with advertisements on the online system 140 as well as with other applications operating on the online system 140. In some embodiments, data from the action log 220 is used to infer interests or preferences of a user, augmenting the interests included in the user's user profile and allowing a more complete understanding of user preferences.

The action log 220 may also store user actions taken on a third party system 130, such as an external website, and communicated to the online system 140. For example, an e-commerce website may recognize a user of an online system 140 through a social plug-in enabling the e-commerce website to identify the user of the online system 140. Because users of the online system 140 are uniquely identifiable, e-commerce websites, such as in the preceding example, may communicate information about a user's actions outside of the online system 140 to the online system 140 for association with the user. Hence, the action log 220 may record information about actions users perform on a third party system 130, including webpage viewing histories, advertisements that were engaged, purchases made, and other patterns from shopping and buying.

In one embodiment, the edge store 225 stores information describing connections between users and other objects on the online system 140 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the online system 140, such as expressing interest in a page on the online system 140, sharing a link with other users of the online system 140, and commenting on posts made by other users of the online system 140.

In one embodiment, an edge may include various features each representing characteristics of interactions between users, interactions between users and objects, or interactions between objects. For example, features included in an edge describe rate of interaction between two users, how recently two users have interacted with each other, the rate or amount of information retrieved by one user about an object, or the number and types of comments posted by a user about an object. The features may also represent information describing a particular object or user. For example, a feature may represent the level of interest that a user has in a particular topic, the rate at which the user logs into the online system 140, or information describing demographic information about a user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 225 also stores information about edges, such as affinity scores for objects, interests, and other users. Affinity scores, or “affinities,” may be computed by the online system 140 over time to approximate a user's interest in an object, an interest or in another user in the online system 140 based on the actions performed by the user. A user's affinity may be computed by the online system 140 over time to approximate a user's interest in an object, a topic, or another user in the online system 140 based on the actions performed by the user. Computation of affinity is further described in U.S. patent application Ser. No. 12/978,265, filed on Dec. 23, 2010, U.S. patent application Ser. No. 13/690,254, filed on Nov. 30, 2012, U.S. patent application Ser. No. 13/689,969, filed on Nov. 30, 2012, and U.S. patent application Ser. No. 13/690,088, filed on Nov. 30, 2012, each of which is hereby incorporated by reference in its entirety. Multiple interactions between a user and a specific object may be stored as a single edge in the edge store 225, in one embodiment. Alternatively, each interaction between a user and a specific object is stored as a separate edge. In some embodiments, connections between users may be stored in the user profile store 205, or the user profile store 205 may access the edge store 225 to determine connections between users.

The online system 140 includes a topic extraction engine 230, which identifies one or more topics associated with objects in the content store 210. To identify topics associated with content items, the topic extraction engine 230 identifies anchor terms included in a content item and determines a meaning of the anchor terms as further described in U.S. application Ser. No. 13/167,701, filed on Jun. 24, 2011, which is hereby incorporated by reference in its entirety. For example, the topic extraction engine 230 determines one or more topics associated with a content item maintained in the content store 210. The one or more topics associated with a content item are stored and associated with an object identifier corresponding to the content item. In various embodiments, associations between object identifiers and topics are stored in the topic extraction engine 230 or in the content store 210 to simplify retrieval of one or more topics associated with an object identifier or retrieval of object identifiers associated with a specified topic. Structured information associated with a content item may also be used to extract a topic associated with the content item. The topic extraction engine 230 may identify topics associated with advertisement content included in an ad request as well as topics associated with a landing page included in the ad request based on content presented by the landing page.

One or more advertisement requests (“ad requests”) are included in the ad store 235. An advertisement request includes advertisement content and a bid amount. The advertisement content is text, image, audio, video, or any other suitable data presented to a user. The advertisement content may also include identifiers identifying the text, image audio, video or any other data included in the advertisement. In various embodiments, the advertisement content also includes a landing page specifying a network address to which a user is directed when the advertisement is accessed. The bid amount is associated with an advertisement by an advertiser and is used to determine an expected value, such as monetary compensation, provided by an advertiser to the online system 140 if the advertisement is presented to a user, if the advertisement receives a user interaction, or based on any other suitable condition. For example, the bid amount specifies a monetary amount that the online system 140 receives from the advertiser if the advertisement is displayed and the expected value is determined by multiplying the bid amount by a probability of the advertisement being accessed.

Additionally, an advertisement request may include one or more targeting criteria specified by the advertiser. Targeting criteria included in an advertisement request specify one or more characteristics of users eligible to be presented with advertisement content in the advertisement request. For example, targeting criteria are used to identify users having user profile information, edges or actions satisfying at least one of the targeting criteria. Hence, targeting criteria allow an advertiser to identify users having specific characteristics, simplifying subsequent distribution of content to different users.

In one embodiment, targeting criteria may specify actions or types of connections between a user and another user or object of the online system 140. Targeting criteria may also specify interactions between a user and objects performed external to the online system 140, such as on a third party system 130. For example, targeting criteria identifies users that have taken a particular action, such as sending a message to another user, using an application, joining a group, leaving a group, joining an event, generating an event description, purchasing or reviewing a product or service using an online marketplace, requesting information from a third-party system 130, or any other suitable action. Including actions in targeting criteria allows advertisers to further refine users eligible to be presented with content from an advertisement request. As another example, targeting criteria identifies users having a connection to another user or object or having a particular type of connection to another user or object.

The ad manager 240 selects advertisement content from the ad requests in the ad store 235 for presentation to an online system user. When selecting advertisement content, the ad manager accounts for the bid amounts associated with ad request included in the ad store 235. For example, the ad manager 240 determines an expected value associated with various ad requests, with an ad request's expected value based on the ad request's bid amount and a likelihood of the user interacting with advertisement content in the ad request. Based on the expected value associated with the ad requests, the ad manager 240 selects advertisement content from one or more ad requests for presentation to the user.

In addition to selecting advertisement content for presentation to online system users, the ad manager 240 also determines whether advertisement content included in an ad request differs from content of a landing page included in the ad request. Malicious advertisers intending to direct users to a malicious landing page may obscure the landing page by including the landing page in an ad request along with advertisement content that is unrelated to the landing page, such as advertisement content with which a user is likely to interact. When the user interacts with the presented advertisement content, the user is directed to the landing page, which may be malicious or unrelated to the advertisement content. By including malicious content in a landing page rather than in advertisement content, advertisers may circumvent many conventional an automated techniques used by systems to identify malicious content in advertisements.

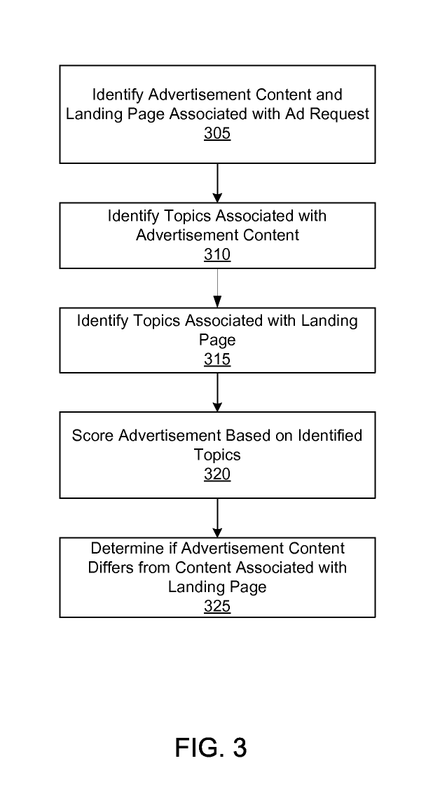

Various methods may be used by the ad manager 240 to determine if advertisement content in an ad request differs from content associated with a landing page specified by the ad request. The ad manager 240 may identify topics associated with advertisement content included in the ad request and identify topics associated with content included in a landing page associated with the ad request. Based on a comparison of the topics associated with the advertisement content and the topics associated with the landing page, the ad manager 240 determines if an ad request includes advertisement content differing from content associated with a landing page specified by the ad request, as further described below in conjunction with FIG. 3.

The web server 245 links the online system 140 via the network 120 to the one or more client devices 110, as well as to the one or more third party systems 130. The web server 140 serves web pages, as well as other web-related content, such as JAVA®, FLASH®, XML and so forth. The web server 245 may receive and route messages between the online system 140 and the client device 110, for example, instant messages, queued messages (e.g., email), text messages, short message service (SMS) messages, or messages sent using any other suitable messaging technique. A user may send a request to the web server 245 to upload information (e.g., images or videos) that are stored in the content store 210. Additionally, the web server 245 may provide application programming interface (API) functionality to send data directly to native client device operating systems, such as IOS®, ANDROID™, WEBOS®, or BlackberryOS.

### Identifying Differences Between Advertisement and Landing Page Content

FIG. 3 is a flow chart of one embodiment of a determining whether content in an ad request differs from content associated with a landing page specified by the ad request. In one embodiment, the functionality described in conjunction with FIG. 3 is performed by the ad manager 240; however, in other embodiments, any suitable component or combination of components may provide the functionality described in conjunction with FIG. 3. Additionally, in some embodiments, different and/or additional steps than those identified in FIG. 3 may be performed, or the steps identified in FIG. 3 may be performed in different orders.

The online system 140 receives ad requests from one or more advertisers that include advertisement content for presentation to online system users and that identify a landing page including content for presentation to users that interact with presented advertisement content. To determine if advertisement content presented by an ad request differs from content associated with a landing page specified by the ad request, the online system 140 identifies 305 advertisement content associated with the ad request as well as a landing page associated with the ad request. The online system 140 may retrieve advertisement content associated with the advertisement and an identification of the landing page (e.g., a network address) from the ad store 235.

One or more topics associated with the advertisement content are identified 310 by the online system 140. For clarity, topics associated with advertisement content are referred to herein as “advertisement content topics.” Various methods may be used to identify 310 the one or more topics associated with the advertisement content. For example, the online system 140 identifies an anchor term in the text of the advertisement content and identifies candidate meanings of the anchor term from information stored by the online system 140. The context of the anchor term in the advertisement content is determined, and a score is determined for each candidate meaning based on the determined context. Any information that may be relevant to determining a meaning of the anchor term may be identified as context of the anchor term. Example information used as context of the anchor term includes information about other terms used in the advertisement content and information related to a possible meaning of the anchor term. A candidate meaning is selected based on the determined scores and is associated with the advertisement content as an advertisement content topic. Use of anchor terms to identify topics is further described in U.S. application Ser. No. 13/167,701, filed Jun. 24, 2011, which is incorporated by reference in its entirety.

Other methods for identifying 310 topics associated with advertisement content may be used in other embodiments. For example, if advertisement content primarily includes images, image processing techniques are applied to the advertisement content to identify objects from the advertisement content. The identified objects are compared to stored information to identify 310 one or more topics associated with the advertisement content. Similarly, the online system 140 may identify 310 topics associated with the identified advertisement content by comparing text included in the advertisement content to stored information to identify one or more subjects or topics most likely associated with one or more terms in the advertisement content text.

Similarly, the online system 140 retrieves content from the identified landing page and identifies 315 one or more topics associated with the landing page. The methods described above for identifying 310 advertisement content topics may also be used to identify 315 one or more topics associated with the landing page based on the content retrieved from the landing page.

Based on the advertisement content topics and the one or more topics associated with the landing page, the online system 140 scores 320 the ad request. In one embodiment, the online system 140 scores 320 an advertisement based on a number of topics associated with the landing page matching or similar to an advertisement content topic. Alternatively, the online system 140 scores 320 the ad request based on a number of topics identified as advertisement content topics and topics associated with the landing page. In another embodiment, the online system 140 scores 320 the ad request by determining a percentage of topics associated with the landing page that are also identified 310 as advertisement content topics. As a further example, the online system 140 scores 320 the ad request based on the following equation:

$$\frac{{( \begin{matrix}number of landing page topics that overlap \\ with advertisement content topics\end{matrix} )}^{2}}{\begin{matrix}( number of advertisement topics ) \\ ( number of landing page topics )\end{matrix}} \qquad ( 1 )$$

As an additional example, the online system 140 scores 320 the ad request by determining the probability of the landing page including the one or more topics associated with the landing page given that the advertisement content includes the advertisement content topics. For example, the advertisement content topics include “sports bar,” “alcohol,” and “televised sporting events,” while the landing page is associated with topics including “casual dating” and “online dating.” The online system 140 scores 320 the ad request by determining the probability of the landing page including the topics “casual dating” and “online dating” given that the advertisement content of the ad request includes the topics “sports bar,” “alcohol,” and “televised sporting events.” A table including various probabilities associated with various combinations of topics may be maintained by the online system 140 and used to determine the probabilities discussed above. The online system 140 may generate the table including the probabilities from a training set including different combinations of advertisement content topics and topics associated with a landing page. Alternatively, the online system 140 may apply a trained model to the advertisement content topics and the topics associated with the landing page to determine the probabilities.

In another embodiment, the online system 140 scores 320 the ad request by comparing the advertisement content page topics to the one or more topics associated with the landing page to identify matching or similar topics. An approximate string matching algorithm or a fuzzy matching algorithm may be used to determine a confidence score representing the likelihood of an advertisement content topic matching a topic associated with a landing page. Based on the number of advertisement content topics matching or similar to a topic associated with the landing page and the associated confidence scores of the matching or similar topics, the online system 140 scores 320 the ad request. For example, the online system 140 may weight each matching pair of topics based on its associated confidence score or based or subject matter associated with a matching pair of topics. However, any suitable method may be used to score 320 the ad request based at least in part on the topics associated with the landing page and the advertisement content topics.

Based on the score associated with the ad request, the online system 140 determines 325 if the ad request includes advertisement content differing from content associated with the landing page specified by the ad request. In one embodiment, the online system 140 compares the score associated with the ad request to a threshold value, and determines 325 whether the ad content differs from the content associated with the landing page based on the result of the comparison. For example, if the ad request is scored 320 based on the probability of the landing page including the topics associated with the landing page given that the advertisement content includes the advertisement content topics, the online system 140 determines 325 the advertisement content differs from the content associated with the landing page if the score associated with the ad request is less than a threshold value. The online system 140 may determine the difference between the score associated with the ad request and the threshold value, and further determines the ad request is associated with malicious content if the difference equals or exceeds a specified amount.

In some embodiments, the online system 140 modifies the threshold value or the specified amount, based on the advertisement content topics or the topics associated with the landing page. For example, the online system 140 increases or decreases the threshold value based on a number of advertisement content topics or on a number of topics associated with the landing page. As another example, the threshold value is determined from a training set of ad requests including advertisement content topics.

If the online system 140 determines 325 the advertisement content of the ad request differs from content associated with a landing page identified by the ad request, the online system 140 may flag the ad request for manual review to verify the determined discrepancy between advertisement content and content associated with the landing page. For example, the online system 140 stores an identifier associated with the ad request along with a value indicating manual review of the ad request in the ad store 235. Alternatively, the online system 140 identifies an ad request determined 325 to include advertisement content differing from content associated with the ad request's landing page as ineligible for presentation to online system users.

### SUMMARY

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method comprising:
retrieving advertisement content and an identifier of a landing page from an advertisement request (“ad request”) stored by an online system;
identifying one or more advertisement content topics from the advertisement content, each advertisement content topic representing subject matter included in the advertisement content;
retrieving content associated with the landing page corresponding to the identifier of the landing page;
identifying one or more topics associated with the landing page based on the retrieved content associated with the landing page, each topic associated with the landing page representing subject matter included in the landing page;
scoring the ad request based at least in part on the one or more advertisement content topics and on the one or more topics associated with the landing page; and
determining whether the landing page includes content differing from content included in the advertisement content based at least in part on the scoring.

2. The method of claim 1, wherein scoring the advertisement based at least in part on the one or more advertisement content topics and on the one or more topics associated with the landing page comprises:
identifying a number of topics included in both the one or more advertisement content topics and in the one or more topics associated with the landing page; and
scoring the advertisement based on the identified number of topics.

3. The method of claim 1, wherein scoring the advertisement based at least in part on the one or more advertisement content topics and on the one or more topics associated with the landing page comprises:
determining a probability of the landing page being associated with the one or more topics associated with the landing page given the one or more advertisement content topics; and
scoring the advertisement based at least in part on the determined probability.

4. The method of claim 1, wherein scoring the advertisement based at least in part on the one or more advertisement content topics and on the one or more topics associated with the landing page comprises:
determining a number of the one or more topics associated with the landing page matching an advertisement content topic;
determining a product of a number of the advertisement content topics and a number of the one or more topics associated with the landing page; and
scoring the advertisement based at least in part on a ratio of a square of the determined number to the determined product.

5. The method of claim 1, wherein determining whether the landing page includes content differing from content included in the advertisement content based at least in part on the scoring comprises:
comparing the score of the ad request to a threshold value; and
determining whether the landing page includes content differing from content included in the advertisement content based at least in part on the comparing.

6. The method of claim 5, wherein determining whether the landing page includes content differing from content included in the advertisement content based at least in part on the comparing comprises:
determining the landing page includes content differing from content included in the advertisement content if the score of the ad request is less than the threshold value.

7. The method of claim 5, wherein the threshold value is determined based at least in part on a training set including a plurality of topics.

8. The method of claim 5, wherein the threshold value is determined based on one or more of the advertisement content topics or the one or more topics associated with the landing page.

9. The method of claim 1, further comprising:
responsive to determining the landing page includes differing from content included in the advertisement content, identifying the ad request for manual review.

10. The method of claim 1, further comprising:
responsive to determining the landing page includes differing from content included in the advertisement content, identifying the ad request as ineligible for presentation to users of the online system.

11. The method of claim 1, wherein identifying one or more advertisement content topics from the advertisement content comprises:
identifying one or more terms included in the advertisement content; and
identifying the one or more advertisement content topics based at least in part on the identified one or more terms.

12. The method of claim 1, wherein identifying one or more topics associated with the landing page based on the retrieved content associated with the landing page comprises:
identifying one or more terms included in the retrieved content associated with the landing page; and
identifying the one or more topics associated with the landing page based at least in part on the identified one or more terms.

13. A computer program product comprising a computer-readable storage medium having instructions encoded thereon that, when executed by the processor, cause the processor to:
retrieve advertisement content and an identifier of a landing page from an advertisement request (“ad request”) stored by an online system;
identify one or more advertisement content topics from the advertisement content, each advertisement content topic representing subject matter included in the advertisement content;
retrieve content associated with the landing page corresponding to the identifier of the landing page;
identify one or more topics associated with the landing page based on the retrieved content associated with the landing page, each topic associated with the landing page representing subject matter included in the landing page;
score the ad request based at least in part on the one or more advertisement content topics and on the one or more topics associated with the landing page; and
determine whether the landing page includes content differing from content included in the advertisement content based at least in part on the scoring.

14. The computer program product of claim 13, wherein score the advertisement based at least in part on the one or more advertisement content topics and on the one or more topics associated with the landing page comprises:
identify a number of topics included in both the one or more advertisement content topics and in the one or more topics associated with the landing page; and
score the advertisement based on the identified number of topics.

15. The computer program product of claim 13, wherein score the advertisement based at least in part on the one or more advertisement content topics and on the one or more topics associated with the landing page comprises:
determine a probability of the landing page being associated with the one or more topics associated with the landing page given the one or more advertisement content topics; and
score the advertisement based at least in part on the determined probability.

16. The computer program product of claim 13, wherein score the advertisement based at least in part on the one or more advertisement content topics and on the one or more topics associated with the landing page comprises:
determine a number of the one or more topics associated with the landing page matching an advertisement content topic;
determine a product of a number of the advertisement content topics and a number of the one or more topics associated with the landing page; and
score the advertisement based at least in part on a ratio of a square of the determined number to the determined product.

17. The computer program product of claim 13, wherein determine whether the landing page includes content differing from content included in the advertisement content based at least in part on the scoring comprises:
compare the score of the ad request to a threshold value; and
determine whether the landing page includes content differing from content included in the advertisement content based at least in part on the comparing.

18. The method of claim 17, wherein determine whether the landing page includes content differing from content included in the advertisement content based at least in part on the comparing comprises:
determine the landing page includes content differing from content included in the advertisement content if the score of the ad request is less than the threshold value.

19. The computer program product of claim 13, wherein the computer readable storage medium further has instructions encoded thereon that, when executed by the processor, cause the processor to:
responsive to determining the landing page includes differing from content included in the advertisement content, identify the ad request for manual review.

20. The computer program product of claim 13, wherein the computer readable storage medium further has instructions encoded thereon that, when executed by the processor, cause the processor to:
responsive to determining the landing page includes differing from content included in the advertisement content, identify the ad request as ineligible for presentation to users of the online system.
